(19) United States
(12) Patent Application Publication
(10) Pub. No.: US 2010/0295389 A1
(43) Pub. Date: Nov. 25, 2010

(54) AXIAL FLUX SWITCHED RELUCTANCE MOTOR AND METHODS OF MANUFACTURE

(76) Inventors: Lynn P. Tessier, Eckville (CA); John P. Doyle, Calgary (CA); James L. Weber, Calgary (CA)

Correspondence Address: SHERIDAN ROSS PC, 1560 BROADWAY, SUITE 1200, DENVER, CO, 80202, US

(21) Appl. No.: 12/304,086

(22) PCT Filed: Jun. 12, 2007
(86) PCT No.: PCT/CA07/01033

§ 371 Date: Dec. 9, 2008

(30) Foreign Application Priority Data
Jun. 12, 2006 (CA) 2549882

(51) Int. Cl. H02K 19/06; H02K 16/00; H02K 15/02

(52) U.S. Cl. 310/46; 29/598

(57) ABSTRACT

An axial flux switched reluctance motor utilizes one or more rotor discs spaced along a rotor shaft, each rotor disc having a plurality of rotor poles spaced along the periphery thereof. Stator elements are distributed circumferentially about the rotor discs and form pairs of radially extending stator poles for axially straddling the rotor discs. Stator coils as switched on to energize pairs of stator poles for forming an axial and radially inward flux path for rotating the rotor poles for minimizing the flux path before switching off the stator coil. Two or more rotor discs can be rotationally indexed for providing two or more motor phases. In manufacture, rotor discs and circumferentially extending stator coils about the periphery of each rotor disc are fit to a stator housing. Each stator element is then fit radially through the stator housing and secured thereto for straddling the rotor discs.

### CROSS-REFERENCE TO RELATED APPLICATION

This application claims the benefit of U.S. Provisional Patent application Ser. No. 60/804,564, filed Jun. 12, 2006, the entirety of which is incorporated herein by reference.

### FIELD OF THE INVENTION

The present invention relates to axial flux switched reluctance motors and more particularly to motors using a one or more rotor discs, circumferentially-wound coils and circumferentially-spaced stators arranged axially to straddle each of the rotor discs forming axial air gaps.

### BACKGROUND OF THE INVENTION

Conventional cylindrical switch reluctance (SR) motors (SRM) typically utilize rotors with poles extending along the rotor and corresponding stators extending axially along the rotor. The circumferential flux path of such motors is along a significant angular portion of the motor: in a 6 pole rotor being ½ of the circumference of the motor and in a 12 pole motor, being ¼ of the away around contributing to iron losses. Copper windings of the coils are intricate, being wound about discrete poles and having ineffective coil-end connectors to the next pole contributing to copper losses. Further, cylindrical switched reluctance motors are plagued by noise as radial flexure of the machine housing. Some noise issues are resolved using axial flux motors such as that set for in U.S. Pat. No. 5,177,392 assigned to Westinghouse Electrical Corp.

Axial flux motors conventionally utilize one or more axially stacked and radially extending rotor disks. Each rotor disc utilizes circumferentially placed poles. Typically a plurality of “U”-shaped stators, each having two poles is arranged tangentially along the periphery of each rotor and radially positioned to magnetically influence a corresponding pair of rotor disk poles. This arrangement is common to a variety of axial flux motor designs including permanent magnet rotor designs such as those in the that family of patents to CORE Innovation, LLC such as that set forth in WO 2004/073365 and those currently assigned to Turbo Genset Company Limited such as U.S. Pat. No. 5,021,698 and wound rotor designs such as that described by Westinghouse Electric Corp in U.S. Pat. No. 5,177,392.

In existing commercial art axial flux SRM designs, an upper U-shaped stator is arranged above the disc and a corresponding lower U-shaped stator is arranged below the disc. An air gap is formed between the poles of each stator pole and the disc. An air gap flux path between the two poles of the upper stator passes about the stator coil from one pole, through the disc, and through the other pole. Similarly, an air gap flux path between the two poles of the lower stator passes from one pole, through the disc, and to the other pole. It is known that air gap spacing can vary between the upper and lower U-shaped stators resulting in differential attractive forces and causing an axial loading on the rotor.

In all of these designs, the flux path includes a circumferential component in either the stator or rotor or both.

Further, the winding of each rotor and stator are conventional and therefor complex, being a series of windings about discrete poles and having ineffective coil-end connectors to the next pole and so on.

### SUMMARY OF THE INVENTION

An axial flux switched reluctance motor is set forth herein having significantly lower iron and copper losses than conventional SR motors. The flux path is markedly shorter requiring less iron in the electrical steel used, the polarity of the poles is fixed resulting in less eddy and hysteresis loss and the coil design requires significantly less copper.

In one embodiment of the present invention an axial flux switched reluctance motor is provided comprising one or more rotor discs spaced along a rotor shaft, each rotor disc having a plurality of rotor poles fit into the periphery of the rotor disc. Each rotor pole is an axially and substantially radially oriented lamination stack of electrical steel. A stator arrangement comprises a plurality of discrete stator elements distributed circumferentially about the periphery of the one or more rotor discs and spaced angularly for driveably influencing the plurality of rotor poles. Each stator element is a laminate stack of electrical steel oriented axially and radially. Each stator element is formed with one or more axially spaced slots forming radially extending stator poles, each slot corresponding with a rotor disc. Stator elements for use with three rotor discs, controlled using three phases, comprises three slots and four stator poles extending radially inward from an axially extending back iron portion, each a stator pole being axially spaced for providing a pair of stator poles straddling each rotor disc therebetween. A stator coil extends circumferentially about each rotor disc and resides in an annulus formed by each slot and radially between the back iron of the stator element and the rotor disc.

Axial air gaps are formed between the axially straddling stator poles and the energizing stator coil for forming a flux path extending between one stator pole, through the rotor disc and to an axially spaced and straddling stator pole of a pair of stator poles. The entire flux path is substantially within a radial plane having radial or axial components and no circumferential components.

Magnetically induced axial loads are neutralized, use of electrical steel is minimized and the windings are simplified and minimizing use of copper.

In one aspect of the invention, an axial flux switched reluctance motor comprises: a rotor shaft having an axis; a rotor disc supported along the rotor shaft and having a plurality of rotor poles fit to a periphery thereof and spaced circumferentially thereabout; one or more axially arranged stator elements spaced circumferentially about the periphery of the rotor disc, each stator element having a back iron portion and pair of stator poles extending radially inward from the back iron for axially straddling the rotor disc and forming axial air gaps between each stator pole and the rotor disc, the back iron portion spaced radially outwards from the periphery for forming an annular slot between the stator elements and the rotor disc; and a stator coil fit to each of the annular slots, wherein a switching on of the stator coil energizes the pairs of stator poles for forming an axial and radially inward flux path for attracting circumferentially adjacent rotor poles to rotate the rotor disc and rotor shaft for moving the rotor poles inline with the energized pair of stator poles for minimizing the flux path before switching off of the stator coil.

In another aspect of the invention, a method of manufacturing an axial flux switched reluctance motor comprises: fitting a plurality of rotor poles to a rotor disc and spacing each of the rotor poles circumferentially about a periphery thereof; mounting one or more of the rotor discs axially along a rotor shaft rotatably mounted in a motor housing; supporting at least one stator element in the motor housing, arranging at least one pair of stator poles of the at least one stator element axially to straddle the rotor disc for forming dual axial air gaps therebetween wherein the stator element connects each stator pole of each pair of stator poles with a back iron portion, and spacing the back iron portion radially outwards from the periphery of the rotor disc for forming a slot therebetween; and fitting a stator coil to each slot for each pair of stator poles and each stator coil adapted for electrical coupling for switched reluctance control wherein upon a switching on of each stator coil energizes its respective pairs of stator poles for forming an axial and radially inward flux path for attracting circumferentially adjacent rotor poles to rotate the rotor disc and rotor shaft for urging the rotor poles inline with the energized pair of stator poles for minimizing the flux path.

### BRIEF DESCRIPTION OF THE DRAWINGS

FIG. 1 is a side cross-sectional view of an embodiment of an axial flux, switched reluctance motor according to one embodiment of the present invention;

FIG. 2 is a perspective, partial cross-section view of the motor of FIG. 1, more particularly a cross-section of the stator showing stacked rotor discs rotatable therein, the poles of each rotor disc being indexed circumferentially relative to each other. The stator coils are shown removed for illustration of the stator element slots extending over the rotor discs;

FIG. 3 is a perspective view of the motor housing of FIG. 1;

FIG. 4 is a perspective view of three rotor discs of FIG. 1 having circumferential stator coils, the top stator coil being removed for illustrating the periphery of the top rotor disc and further including only one of the plurality of stator elements for illustrating the relationship of the stator element and the rotor poles;

FIG. 5 is a top view of the rotor discs and circumferential coils and illustrating two of the plurality of stator elements for illustrating the orientation and relationship of the stator element and the rotor poles;

FIG. 6 is a top cross-section view of the three rotor discs, each cross-section of each success rotor disc being fancifully displaced laterally to better illustrate the circumferential offset of the rotor poles;

FIG. 7 is a side view of a partial arc of the three rotor discs in a flat rolled-out view and with the circumferential coils being partially cutaway to illustrate the rotor poles and one embodiment of the circumferential positioning of each pole for each phase which respect to each other phase;

FIG. 8 is a perspective, partial cross-section view of the motor of FIG. 1, more particularly a cross-section of the stator housing showing a complete view of stacked rotor discs rotatable therein, the circumferential positioning of each pole, and showing a circumferential coil for each rotor disc fit between the stator elements and the periphery of each rotor disc;

FIG. 9 is a perspective exploded view of the motor of FIG. 1 illustrating the end caps sandwiching the motor shroud, the stator housing, stator elements, rotor shaft and rotor discs, and further illustrating the motor shroud, fan and motor end cap;

FIG. 10 is a perspective view of the stator housing, stator elements, rotor shaft and rotor discs with one stator element, wedge insulators and clamps in a radially exploded view, and further illustrating the first and second circumferential coils as transparent to show the poles otherwise obscured beneath;

FIG. 11 is a perspective view of a stator element, wedge insulators and clamps in a radially exploded view;

FIGS. 12A and 12B are top and side cross-sectional views of a single rotor disc embodiment using 5 rotor poles and wherein six stator poles are arranged circumferentially around the rotor disc and are operated on six different phases;

FIG. 13A is a plan view of one possible efficient manufacturing template for electrical steel laminations for both the stator and rotor;

FIG. 13B is an alternate plan view of another possible efficient manufacturing template for electrical steel laminations for both the stator and rotor; and

FIG. 14 is a plan view of a typical prior art manufacturing template for electrical steel laminations for both the stator and rotor.

### DESCRIPTION OF THE PREFERRED EMBODIMENTS

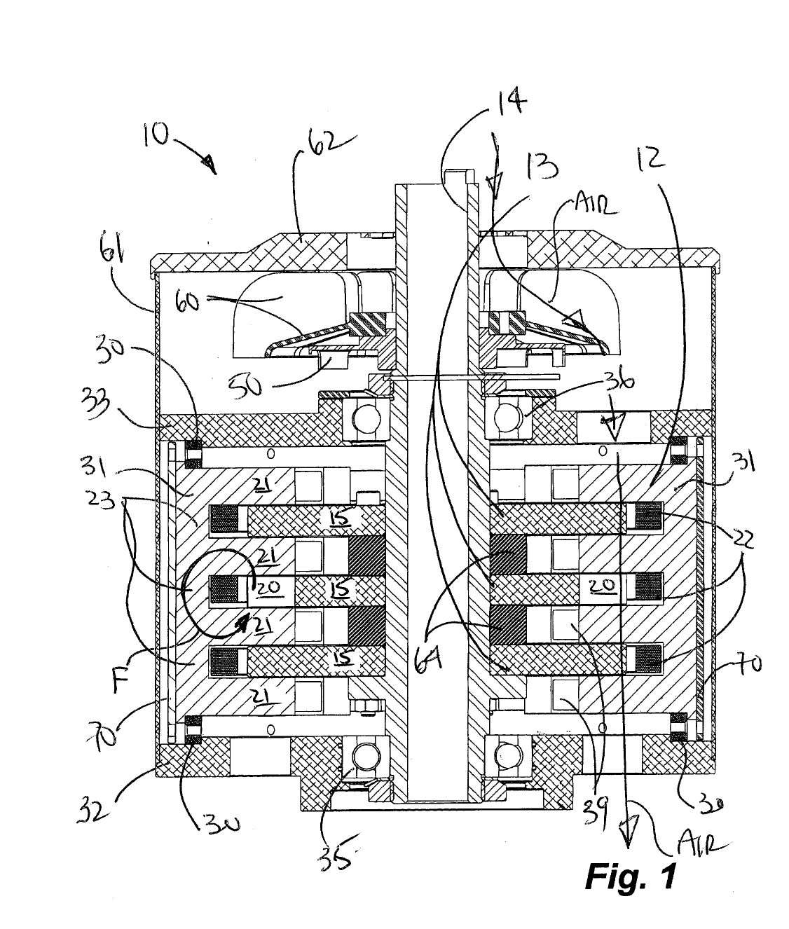

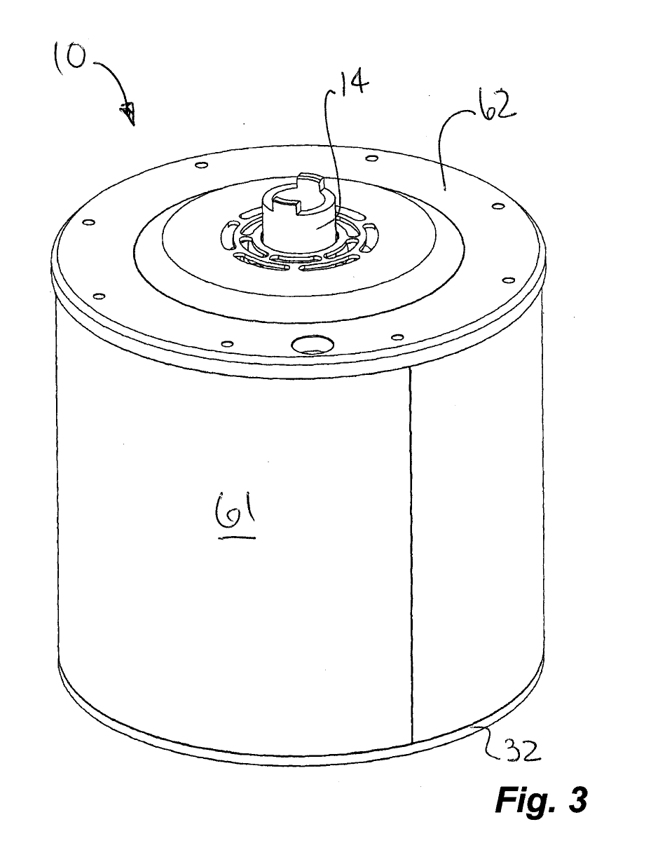

As shown in cross-section FIG. 1 and fully assembled in FIG. 3, an axial flux electromotive generating device or motor 10 using switch reluctance control has a stator arrangement 12 and a rotor 13. The principles of switched reluctance motors are known to those of ordinary skill in the art. Applicant has provided a heretofore unknown and advantageous arrangement of stator arrangement 12 and rotor 13.

The term “switched reluctance” has now become the popular term for a class of electric machine. The topology of conventional switched reluctance motors (SRM) implement phase coils mounted around diametrically opposite stator poles which are radially spaced about a rotor. A conventional SRM rotor has a plurality of radially extending poles. Energizing of a stator phase will cause a rotor pole to move into alignment with corresponding stator poles, thereby minimizing the reluctance of the magnetic flux path. Rotor position information is used to control energizing of each phase to achieve smooth and continuous torque.

In embodiments of the present invention, the rotor 13 comprises a rotor shaft 14 about which are mounted one or more radially extending rotor plates or discs 15. The rotor discs 15 support a plurality of rotor poles 20. Each rotor pole is an axially and substantially radially oriented lamination stack of rotor pole laminations formed of electrical steel. The stator arrangement 12 forms stator poles 21 spaced axially spaced from the rotor discs 15 and rotor poles 20 for forming axial air gaps G. One or more stator coils 22, one per rotor disc 15 are energized to interact with the stator poles 21 and create a magnetic flux. A flux path F is formed between the stator poles 21 and the rotor poles 20. The orientation of the flux path F extending from the stator poles 21 and through the rotor poles 20 is axial, being substantially parallel to the axis of the rotor 13. The entire flux path F is substantially within a radial plane having radial or axial components and no circumferential components. The flux path F is very short, extending only through a back iron portion 23 of the stator pole 21 equivalent to about the axial thickness of a rotor disc 15 as opposed to the conventional SR motor using ¼ to ½ of the circumference of the motor.

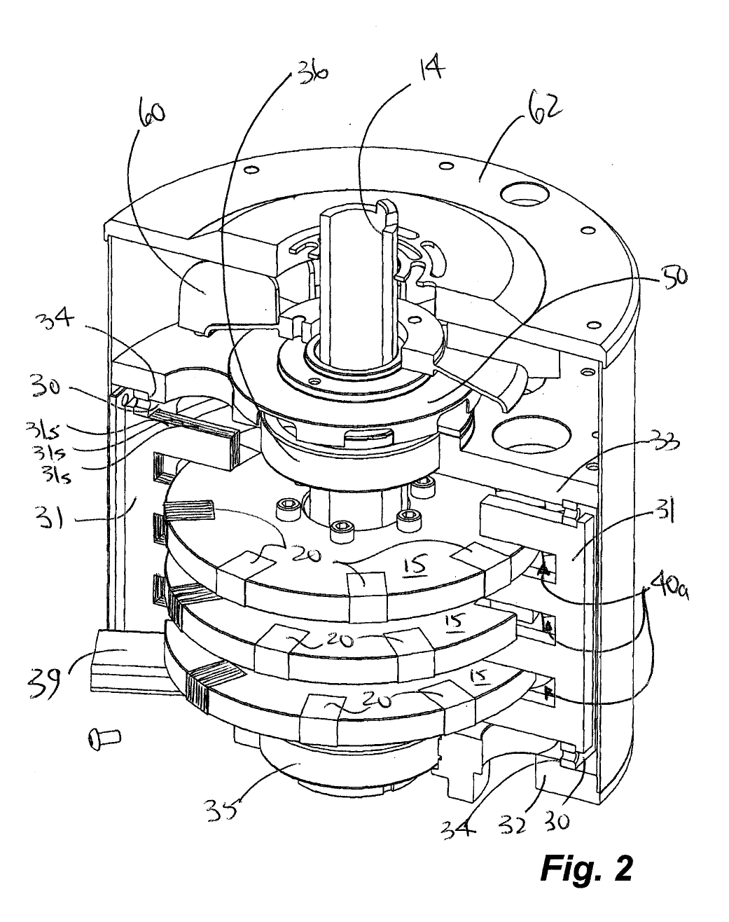

With reference to FIGS. 1 and 2, the stator arrangement 12 is supported in a stator housing 30. The stator arrangement 12 comprises a plurality of discrete stator elements 31 mounted in the stator housing 30 are distributed angularly about the circumferential periphery of the one or more rotor discs 15. Each stator element 31 is formed of a laminate stack 31s, 31s, 31s . . . of stator laminations formed of electrical steel which is arranged or oriented axially and substantially radially to the rotor axis. In this embodiment, each stator element 31 forms a pair of stator poles 21P arranged above and below the rotor disc 15, each stator pole 21,21 of the pair of stator poles 21P being spaced axially therefrom by the axial air gap G.

Each stator element 31 is supported in the stator housing 30 such as through mechanical attachment to the stator housing 30. The stator housing 30 is sandwiched between a first, top bearing end cap 32 and a second, bottom bearing end cap 33. The orienting terms top, bottom and related terms used herein with reference to the drawings are only for descriptive convenience for the reader as the motor 10 is not limited in its orientation for operation.

The first and second bearing end caps 32,33 can form annular steps or ridges 34 for radially supporting the stator housing 30 in its cylindrical form.

The one or more rotor discs 15 extend radially from the rotor shaft 14 which is rotatably mounted between first and second bearings 34,35. The first and second bearing 35, 36 are supported in the top and bottom bearing end caps 32,33. Typically one bearing floats axially to accommodate dimensional changes.

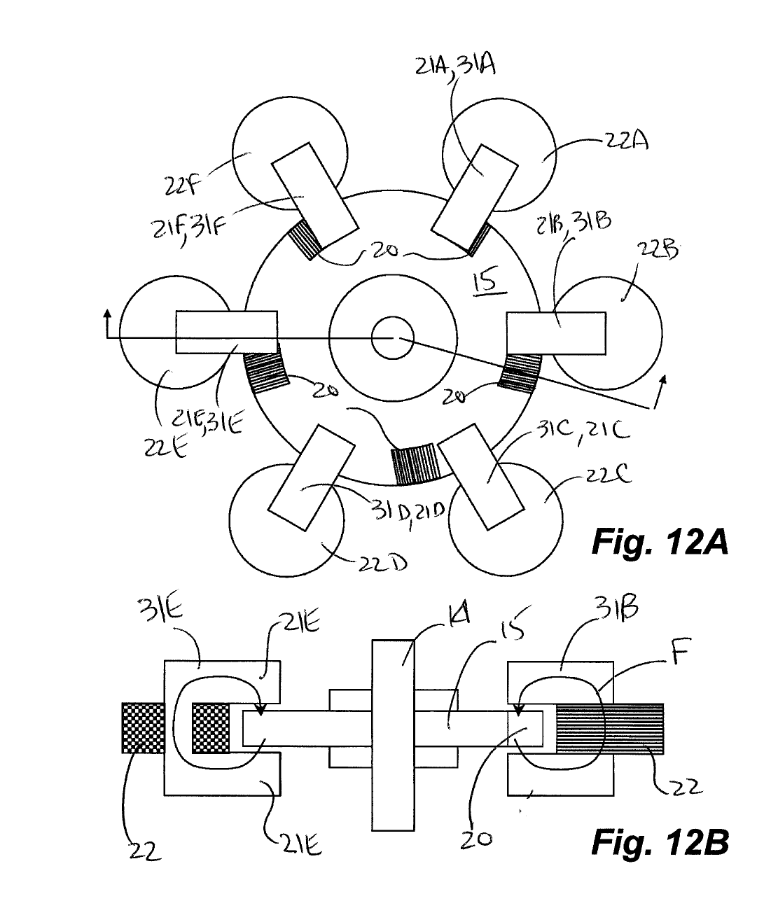

As shown in FIGS. 12A, 12B and in an embodiment implementing only one rotor disc 15, the stator coils 22A, 22B . . . associated with multiple phases A, B, . . . respectively actuate designated stator elements 31A, 31B, . . . to or more stator elements 31A,31B forming two or more stator poles 21A, 21B . . . arranged angularly about the disc 15. As shown in FIG. 12B, each lamination element 31A, 31B . . . forms a pair of stator poles 21P arranged above and below the rotor disc 15, the rotor disc 15 and each stator pole 21,21 of the pair of stator poles 21P being spaced axially therefrom by the axial air gap G.

In such an embodiment, the number of rotor poles 20, 20 . . . can be any integer number including odd numbers and the number stator poles 21, 21 . . . can be equal to the number of power phases or multiples thereof. With this radial arrangement and using switched reluctance control there is no need to match the number of rotor poles 20 and stator poles 21. This is in contradistinction to both conventional radial and conventional axial flux switched reluctance motor designs in which the rotor poles must be arranged in multiples of two and the stator poles must be arranged in multiples of the number of power phases with a minimum of two times the number of power phases. Typically, the stator coils for pairs of diametrically opposing stator poles 22, such as 22A,22D, can be conventionally wired in series for forming each independent phase of a prior art multi-phased switched reluctance motor.

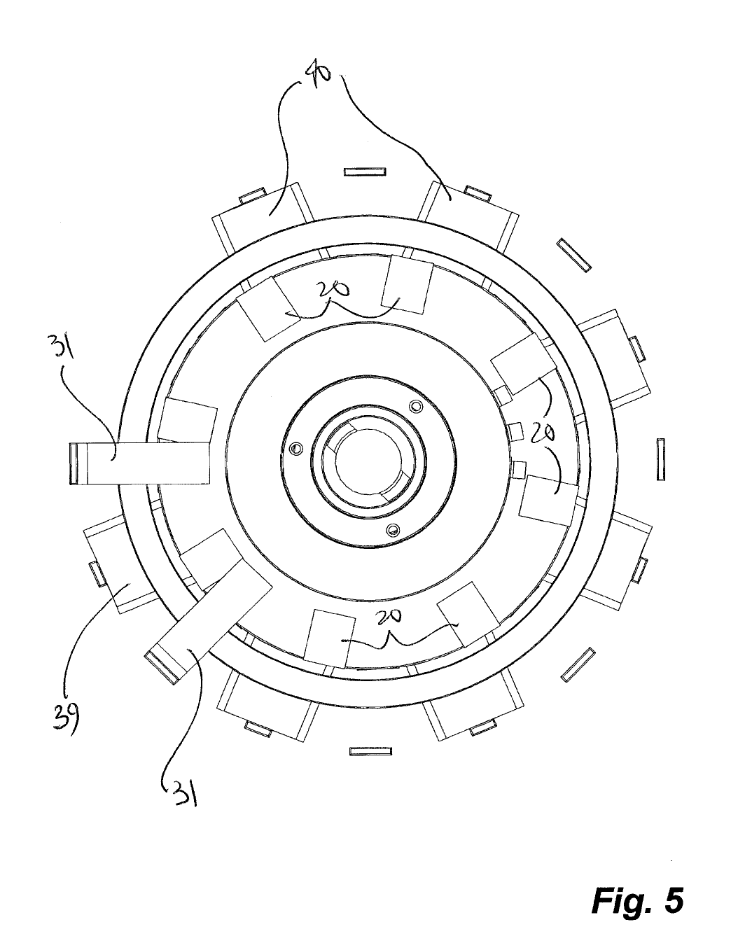

With reference again FIG. 2 and FIGS. 4-8 illustrating an embodiment implementing a plurality of rotor discs 15, the use of multiple rotor discs 15 conveniently enables multiple phases A, B, . . . to be employed wherein one phase influences one rotor disc at a time wherein all stator poles 21 for that particular disc are energized at once using one circumferentially wound stator coil 22.

Each rotor disc 15 has a plurality of discrete and circumferentially spaced rotor poles 20 secured into the rotor disc 15 adjacent a radially peripheral edge, preferably at the peripheral edge. As is known by those of skill in the art that each rotor disc 20 and the stator housing 30 are formed of a non-magnetic material such as aluminum, titanium, many stainless steels and fiber-reinforced plastics (FRP). Each rotor pole 20 is formed of a laminate stack 20s, 20s, 20s . . . of electrical steel oriented axially and radially. The rotor poles 20,20 . . . can be secured in the rotor 12 by such methods as being molded into the disc 15, brazing, gluing or retained by a non-magnetic circumferential restraint or hoop. Methods of affixing the rotor poles 20 in the rotor disc 15 are, for the most part, dependent on the maximum rotational speeds expected. As illustrated, such axial flux motors are capable of about 500 rpm.

Each stator element 31 is oriented axially with its stator poles 21 nested radially into the rotor discs 15. Insulative spacer blocks or wedges 39 can be inserted radially between each circumferentially spaced and successive stator element 31 and secured in place.

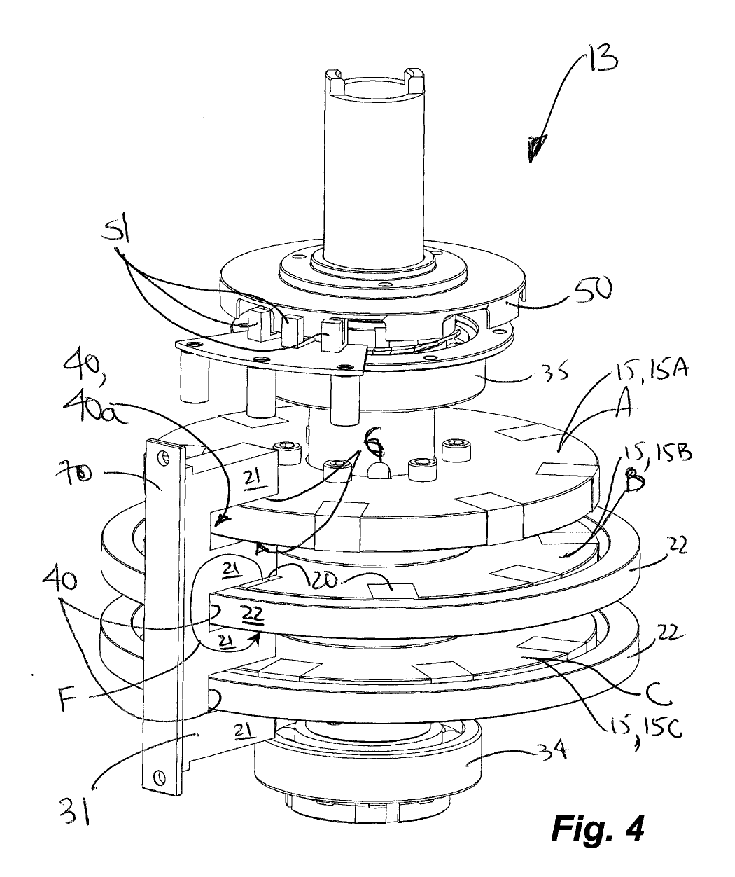

With reference to FIG. 4, along each stator element 31 is formed a plurality of axially spaced slots 40 corresponding with the axial spacing of the rotor discs. For example, a stator element 31 for two rotor discs 15,15 has the form of a capital letter “E”, having 2 slots 40,40 straddled by three stator poles 21,21,21 (two pairs of stator poles 21P) and ultimately resulting in an element 31 having pole 21, slot 40, middle pole 21, slot 40 and pole 21. Circumferentially about the periphery of a rotor discs, the slots 40 of each lamination element 31 form an annular slot 40a about the disc 15.

For three rotor discs 15, as shown, there are three slots 40,40,40 straddled axially by four radial stator poles 21,21,21,21 (three pairs of rotor poles 21P) extending radially inward from the axially extending back iron 23 portion, each a stator pole 21 being axially spaced by the slots 40 for providing a pair of stator poles 21,21 straddling each rotor disc 15 therebetween.

In a multi-phase, multiple rotor disc embodiment, a stator coil 22 is wound circumferentially about each rotor disc 15 and spaced therefrom, the stator coil circumferentially traversing the annular slots 40.

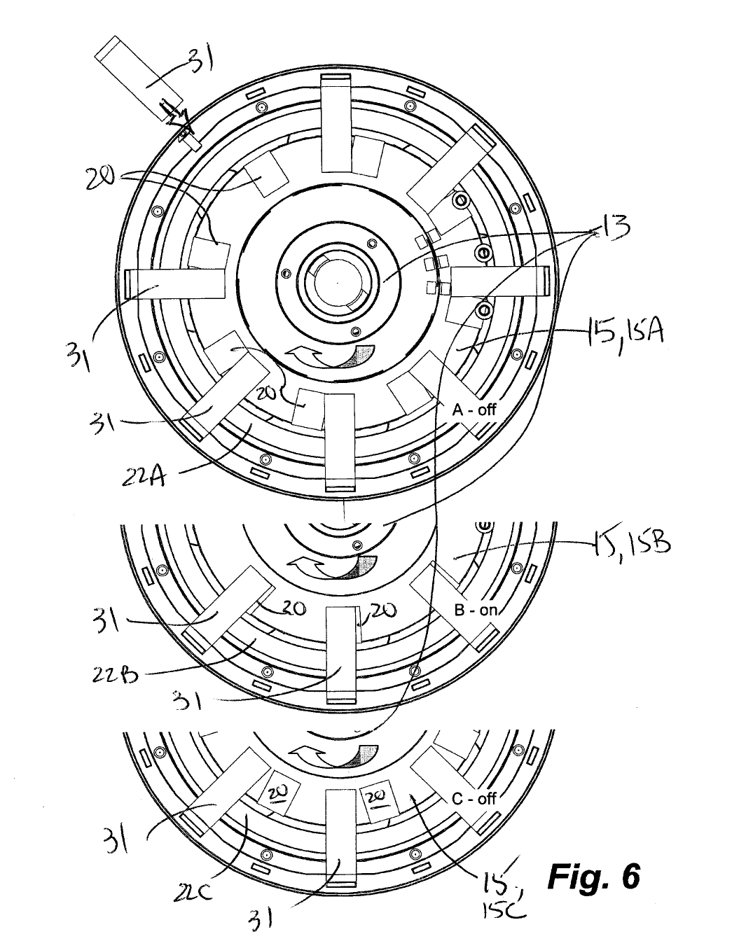

As shown in FIG. 6, eight angularly spaced stator elements 31 provide stator poles 21 circumferentially spaced at 45 degree angular spacing about the rotor discs 15. In this embodiment, there are also eight rotor poles 20 distributed about each rotor disc 15.

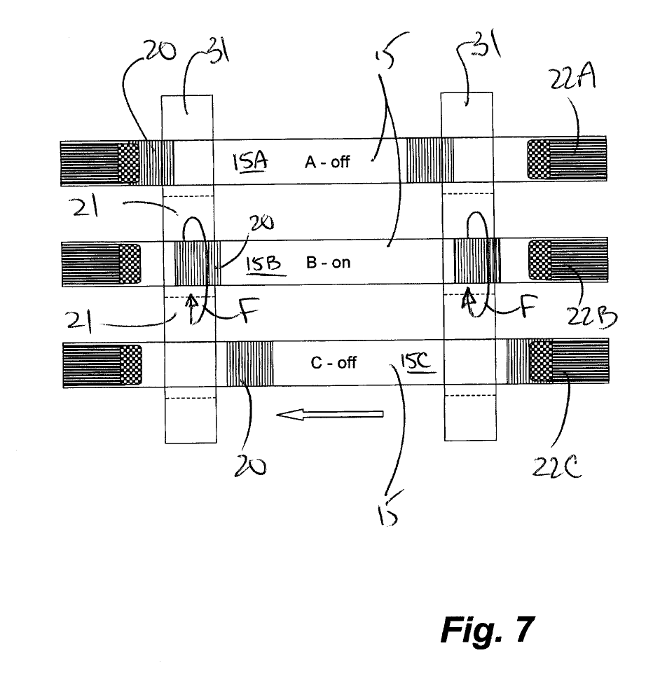

As shown in FIGS. 6 and 7, the angular position of each rotor disc 15 is rotationally indexed for implementing multi-phase operations wherein each rotor disc represents a different phase and the angular starting position of each rotor pole 20 is angularly shifted or indexed. This is in contradistinction to the embodiment of FIGS. 21A and 12B wherein different stators form different phases.

In this multiple rotor disc, multiple phase embodiment as shown in the partial cutaway of FIG. 6 and flat layout of FIG. 7, as the three rotor discs 15A,15B,15C rotate to the left, stator coils 22A and 22C are not energized and stator coil 22B is energized, generating flux paths F for attracting rotor pole 20 of disc 15B between the energized stator poles 21,21. Each rotor disc 15 is secured to the rotor shaft 14 to maintain the rotationally indexed offset such as by three unique keyed attachments between the three different phased rotor discs 15A,15B,15C.

In embodiment, for distributing the rotor poles of each phase equiangularly about the two or more rotor discs, one can set the angular indexing as follows. For n number of rotor discs, each having m number of rotor poles and m lamination elements each rotor disc is angularly incremented from another pole on an adjacent phase of a rotor disc by 360/n/m degrees. In other words, as shown in FIG. 6, for three rotor discs, each having 8 rotor poles and using 8 lamination elements, the rotor poles of each rotor discs are spaced 360/8=45 degrees, and each rotor pole of a phase is angularly incremented by 360/8/3=15 degrees. Correspondingly, each lamination element has n+1 stator poles for forming n pairs of stator poles, one pair for each of the n rotor discs.

Returning to FIG. 4, each element slot 40 is sufficiently radially deep, or conversely each stator pole 21 has sufficient extent radially, to form a radial slot annulus 40a (FIGS. 2,4), sized to accept the circumferentially extending stator coil 22 and still have a stator pole 21 portion extending sufficiently radially over the rotor discs 15 to magnetically engage the rotor poles 20.

There is a circumferentially extending stator coil 22 for each rotor disc 15. The stator coil circumferentially traverses the annular slot 40a.

The stator coil 22 is located adjacent and spaced radially from the periphery of each rotor disc 15. Coil windings for each stator coil begin at a starting connection, extend circumferentially in a circular loop many times in the stator coil about the rotor disc and preferably end at termination connections at about the same angular position as the starting connection. The power leads for each stator coil 22 can be conveniently routed axially between stator elements and through a bearing end cap for connection to an SRM motor controller of conventional construction. While alternate control algorithms could be developed, a conventional and commercially SR motor controller can be used without modification with the embodiments of the present invention.

Each stator coil 22 represents a phase winding. Typically three phases A,B,C are provided and thus three rotor discs 15,15,15 (15A,15B,15C) are employed. The coils 22 are electronically switched (electronically commutated) in a predetermined sequence so as to form a stepwise moving magnetic field. The rotor 13 has no phase windings but each of the plurality of rotor poles 20 are closely axially spaced by the dual axial air gaps G to the pair 21P of straddling stator poles 21,21, one axially above the rotor disc 15 and one below the rotor disc 15.

The electronic switching of the stator coils 22A,22B,22C for each phase produces a moving magnetic field which induces torque through adjacent rotor poles. The rotor disc 15 rotates to move adjacent rotor poles 20 inline with the energized stator poles 21,21 for minimizing the flux path F (minimum reluctance). Generally, a coil 22 for a phase is switched on and off, firstly to capture a rotor pole 20 of its respective rotor disc 15 in its magnetic field when on, and the phase is turned off when the rotor pole is about between the stator poles 21,21. Using predetermined switching of the phases to actuate the appropriate coil and actuate the stator poles for the corresponding rotor disc, the desired rotor speed is achieved, as is control of forward or reverse rotation.

As shown in FIGS. 6 and 7 the B phase is about ready to switch off and phase C is about to turn on.

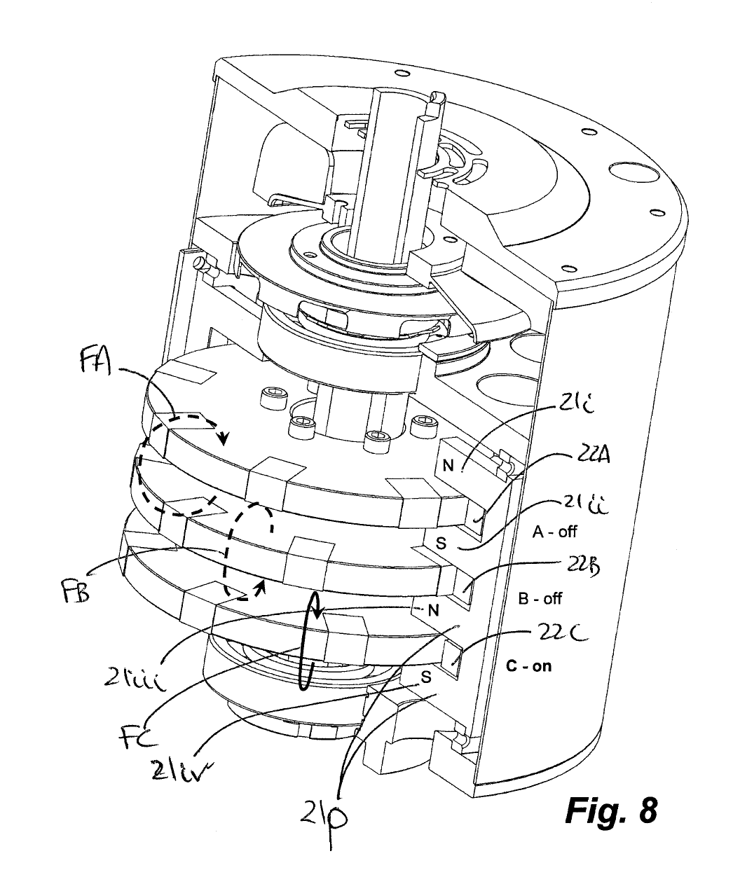

As shown in FIG. 8, the rotor 13 has rotated from the position shown in FIG. 7 and stator coil 22C for Phase C is on (energized) as rotor pole 20 (hidden) is entering between the pair 21P of stator poles 21,21 straddling stator coil 22C and, shortly thereafter, Phase A will turn on. Further, as illustrated, the stator poles 21 can be operated with the same polarity so as to minimize eddy current and hysteresis losses. The flux paths F can be oriented to operate so as to ensure that the polarity of the straddling poles 21 is not changed. As shown, stator coil 22A forms a flux path FA and an arbitrary polarity N is assigned to the top stator pole 211 and accordingly, the next lower stator pole 21ii has a polarity of S. When stator coil 22B is actuated with a reverse flux path FB, the polarity remains as S for stator pole 21ii and accordingly, the polarity of next stator pole 21iii is N. Lastly, when the stator coil 22C is actuated with the same flux path FB as flux path FA, the polarity remains as N for stator pole 21iii and accordingly, the polarity of last stator pole 21iv remains as S.

With reference to FIG. 4, an encoder disc 50 and sensors 51 (such as hall-effect sensors) provided feedback of rotor 13 position for each of the three rotor discs 15,15,15 representing three phases A,B,C. For control in a first clockwise rotational direction, the sensors and SRM controller and software (conventional) sequentially control the triggering of each phase in sequence A,B,C as they relate to each of the first, second and third rotor discs 15A,15B,15C in sequence. In the opposing counter-clockwise rotational directional the sensors and SRM controller and software (conventional) sequentially control the triggering of each phase in sequence A,C,B as they relate to each of the first, second and third rotor discs in sequence.

As shown in FIGS. 4, 8 and 12B, the magnetic flux path F is from one stator pole 21, through the rotor disc 15 and to the next adjacent and straddling stator pole 21 and back to the first stator pole through the axially-oriented back iron portion 23 of the stator element 31. Regardless of any variation in air gap G between stator pole 21 and rotor pole 20, either above or below the subject rotor disc 15, the flux path F is invariant and thus the axial attractive and repulsive forces are balanced across the rotor disc. This arrangement substantially eliminates the axial force fluctuations which can result in flexure and vibrations. Accordingly, there is no built in negative stiffness known to exist in other axial flux machines. Further, conventional issues of radial flexure and noise are avoided due to the elimination of radial attraction and repulsion.

There are both mechanical and electrical complexities and simplifications introduced by the axial flux motor of the present invention.

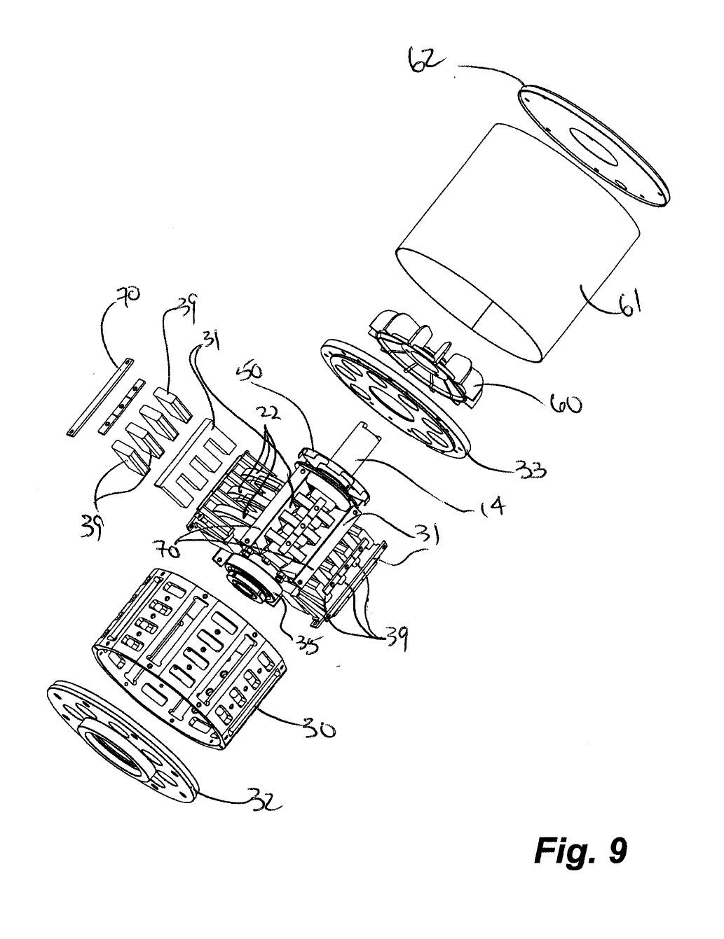

As shown in FIGS. 1 and 9, motor comprises the top and bottom bearing end caps 32, 33 which sandwich the stator arrangement 12, the rotor 13 and stator housing 30 therebetween. The rotor shaft 14 supports a cooling fan 60. A motor shroud 61 encloses the stator housing 30, stator arrangement 12 and rotor 13 and the fan 60 directs cooling air through the motor 10. Removal of the motor shroud 61 enables access to the stator elements and insulative wedges. Also shown in FIG. 3, a motor end cap 62 competes the motor 10. Stator coil 22 power leads (not shown) can exit the shroud 61 or through one of the bearing end caps 32,33 or motor end cap 62.

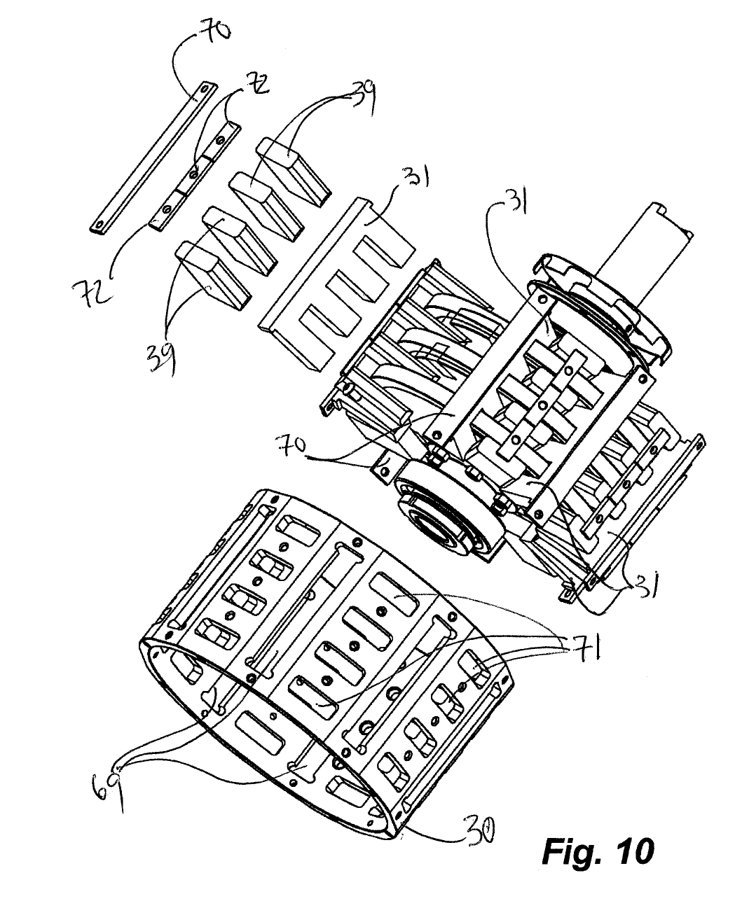

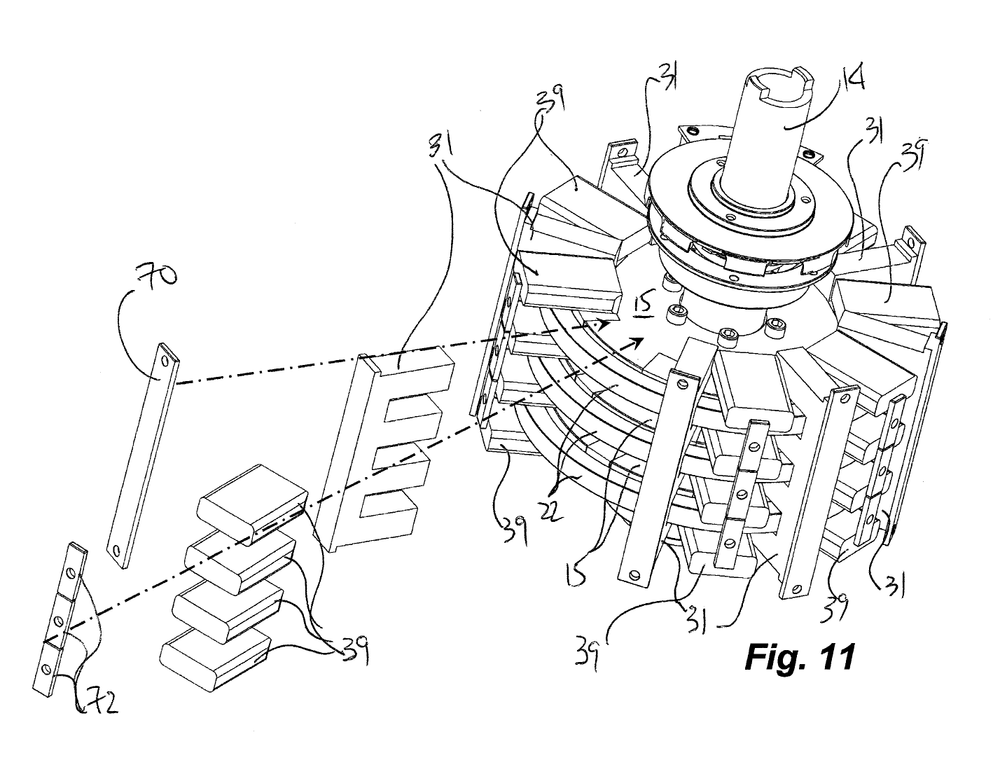

With reference to FIGS. 9, 10 and 11, the assembly and disassembly of the motor 10 is more complex compared to a conventional SRM motor where an axially extending and radially constant rotor is easily inserted and removed axially from a circumferential stator. Using the axial flux motor of the present invention, the stator elements 31 must be installed after the rotor discs 15 and coils 22 are positioned in the motor 10. Stator elements 21 are inserted radially so as to axially straddle each of the one or more rotor discs 15 and coils 22. In an embodiment using multiple rotor discs 15,15,15, and wherein each rotor disc 15 is a unitary integral disc having a central bore, before installing the stator elements 31, the bore of each rotor disc for each phase is inserted over the rotor shaft 14 and secured in an axially spaced and rotationally indexed arrangement to angularly distribute the rotor poles about the motor. Spacer rings 64 (FIG. 1) or washers can provide the spacing corresponding to the spacing of the slots 40 in the stator elements 31, wherein the at least one pair of stator poles of the at least one stator element axially straddle the rotor disc for forming dual axial air gaps G. The circumferentially wound stator coils 22 are installed about the periphery of the rotor discs 15 before the stator elements 31 are installed radially so as to straddle both the stator coils 22 and rotor discs 15 with the stator coils circumferentially traversing the annular slot. A bearing end cap 32,33 can be secured to the stator housing 30 and the stator housing 30 arranged about the rotor discs 15,15,15. The stator elements 31 are installed radially through slots 69 in the stator housing 30 and secured such as be using stator clamp plates 70 fastened to the stator housing. The insulative wedges 39 can be inserted through ports 71 through the stator housing 30 and pairs of adjacent wedges can be retained in place using mechanical clamping plates 72 fastened to the stator housing 30.

The assembly of the mechanical arrangement is out-weighed by the simplification in electrical, weight characteristics and reduced losses inherent in this motor 10. For example, the axial and radially inward flux path flux is much shorter than prior art motors requiring less electrical steel; requiring less than about ½ of the electrical steel used in a conventional radial flux switched reluctance motor design. The multiple rotor disc embodiment results in a simple hoop or circumferentially extending copper coil which requires about ½ of the conventional copper due to the elimination of conventional end connectors and lines between series poles and elimination of the conventional ineffective coil ends and there is an ease of windings manufacture and installation wherein winding complexity prevalent with conventional multiple independent poles is eliminated and replaced with a circular hoop. The polarity of the stator poles does not change and reducing losses. Magnetic flux is balanced axially eliminating axial vibration. Less steel and less copper results in smaller, lighter, cooler and less expensive motors. The magnetic flux path is purely axial, there is no circumferential component to the flux in either the rotor or the stator.

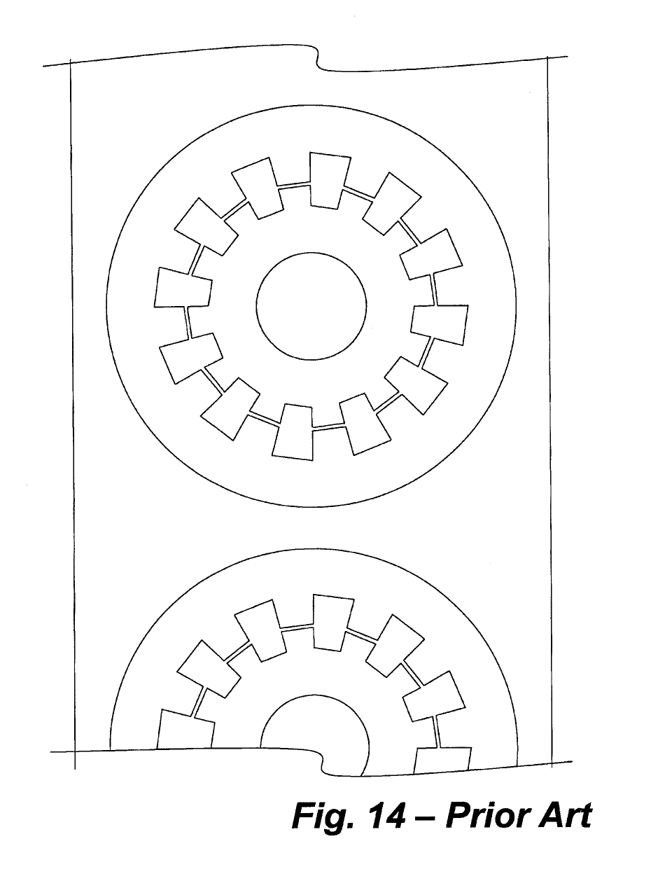

As shown in FIG. 14, a single lamination of a prior art circumferential stator and rotor could be concentrically cut from electrical steel with particular wastage of electrical steel. Any stator element comprises assembling the lamination element from a stack of a plurality of laminations. The stator and rotor portions could be stamped from the same location in the steel, however, a significant mass of steel is required and wastage is also great. Applicant understands that patterns stamping cannot extend to the edges of the raw steel material due to manufacturing constraints of die stamping such as a loss of dimensional tolerances at said edges.

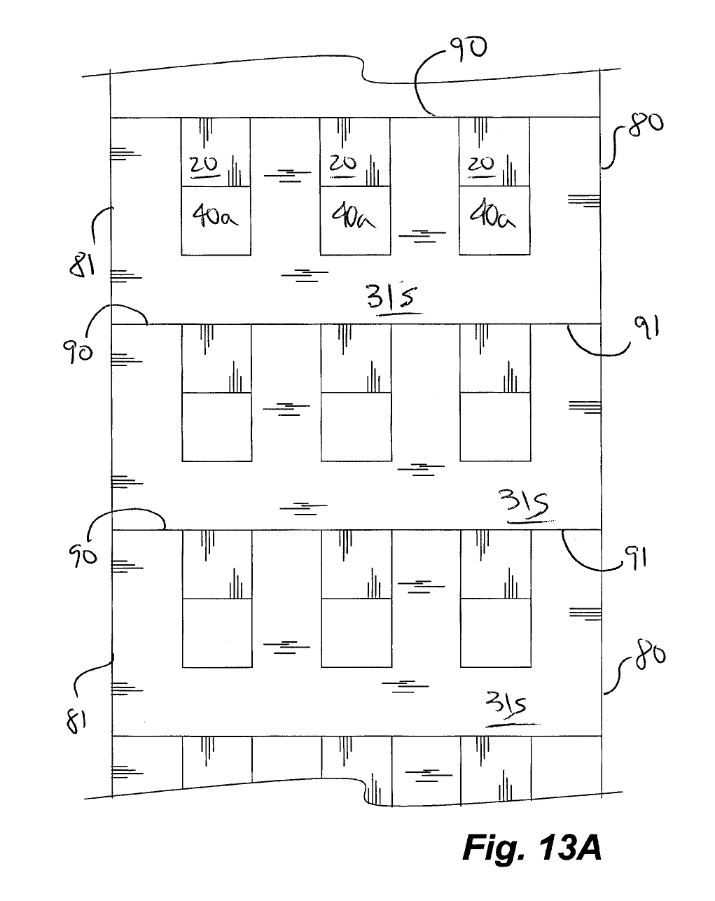

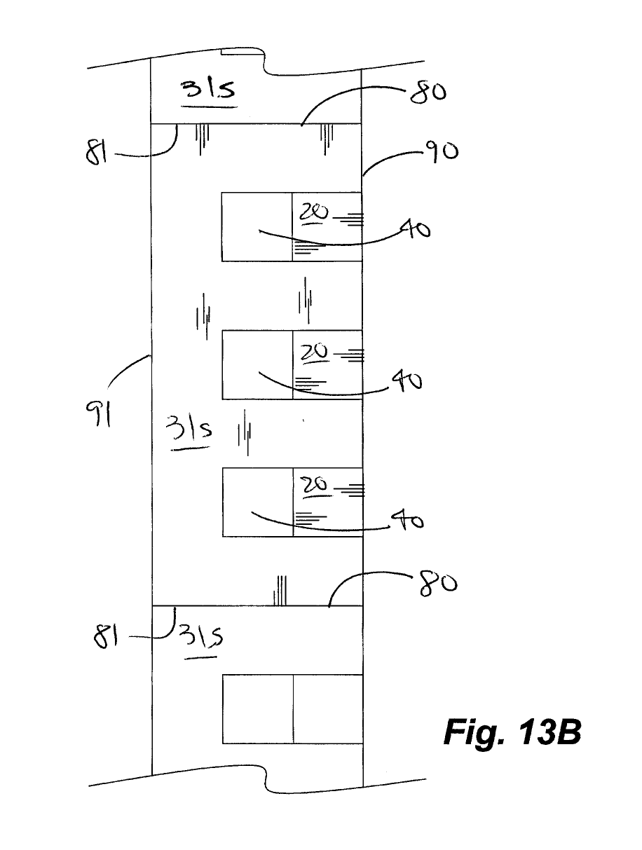

With reference to FIG. 13A, in the manufacture of a single lamination 31s of a stator element 31 and lamination of a rotor pole 20 according to the present invention, much less electrical steel is required, the only loss being a portion of the slots 40 for annular slot 40a through which circumferential stator coils pass. Each stator lamination 31 comprises a top edge 80 and a bottom edge 81 for forming an axial height for accommodating each of the n+1 stator poles and further comprises an inward edge 90 and an outward edge 91 forming a radial depth for accommodating the back iron portion and the inwardly extending stator poles. As shown, each of the stator laminations is formed from the longitudinally extending strip of electrical steel, the strip having a transverse width equal to the element axial height, and the axial height of each lamination is oriented substantially across the entire transverse width of the strip. The stator laminations are formed from the strip with the outside edge 91 of a first adjacent stator lamination as the inside edge 90 of a second adjacent stator lamination.

The electrical steel blank or strip material can be fully utilized to its width as the forming action at the edges is merely to shear the material which can be conducted to an edge. Further, formation of the stator laminations further comprises forming a rotor pole lamination from a portion of the strip removed from the slot for each stator element in each stator lamination.

Similarly, with reference to FIG. 13B, a single lamination 31s of a stator element 31 and rotor pole 20 can be oriented axially rather that transversely as shown in FIG. 13A. Each of the stator laminations is formed from the longitudinally extending strip of electrical steel, the strip having a transverse width equal to the element radial depth, and the radial depth of each stator lamination being oriented substantially across the entire transverse width of the strip. The stator laminations are formed from the strip with the top edge 80 of a first adjacent stator lamination as the bottom edge 81 of a second adjacent stator lamination.

A narrow electrical steel blank or strip material can be fully utilized to its width with notching of the slots 40 and shearing of each axial element 31 for each successive element 31.

1. An axial flux switched reluctance motor comprising:
a rotor shaft having an axis;
a rotor disc supported along the rotor shaft and having a plurality of rotor poles fit to a periphery thereof and spaced circumferentially thereabout;
one or more axially arranged stator elements spaced circumferentially about the periphery of the rotor disc, each stator element having a back iron portion and pair of stator poles extending radially inward from the back iron for axially straddling the rotor disc and forming axial air gaps between each stator pole and the rotor disc, the back iron portion spaced radially outwards from the periphery for forming an annular slot between the stator elements and the rotor disc;
and a stator coil fit to each of the annular slots,
wherein a switching on of the stator coil energizes the pairs of stator poles for forming an axial and radially inward flux path for attracting circumferentially adjacent rotor poles to rotate the rotor disc and rotor shaft for moving the rotor poles inline with the energized pair of stator poles for minimizing the flux path before switching off of the stator coil.

2. The axial flux switched reluctance motor of claim 1 further comprising:
two or more stator elements; and
two or more stator coils, at least one stator coil for each stator element.

3. The axial flux switched reluctance motor of claim 2 wherein the stator elements are arranged in diametrically opposing pairs, and the stator coils for the diametrically opposing stator elements are electrically wired in series.

4. The axial flux switched reluctance motor of claim 1 further comprising:
two or more rotor discs, each rotor disc having the rotor poles;
two or more stator coils, at least one stator coil for each rotor disc, and
wherein the one or more axially arranged stator elements have three or more stator poles for forming two or more pairs of stator poles, one pair for each rotor disc.

5. The axial flux switched reluctance motor of claim 4 wherein the two or more stator coils comprise one stator coil wound circumferentially about each rotor disc and spaced therefrom, the stator coil circumferentially traversing the annular slots.

6. The axial flux switched reluctance motor of claim 4 wherein:
the rotor poles of each of the two or more rotor discs are circumferentially offset from the rotor poles of each other of the two or more rotor discs, and
the stator coil for each rotor disc are switched on in a predetermined sequence for forming a stepwise moving magnetic field.

7. The axial flux switched reluctance motor of claim 4 wherein:
the two or more rotor discs are n rotor discs each having m rotor poles and a stator coil,
the plurality of axially arranged stator elements are an n number of elements equal in number to the m rotor poles and each stator element having n+1 stator poles for forming n pairs of stator poles, one pair for each of the n rotor discs, and
each rotor disc being angularly incremented from another by 360/n/m degrees.

8. The axial flux switched reluctance motor of claim 4 wherein:
the two or more rotor discs are three rotor discs each having two or more rotor poles and a stator coil, and
the plurality of axially arranged stator elements are an even number of stator elements equal in number to the two or more rotor poles and each stator elements having four stator poles for forming three pairs of stator poles, one pair for each of the three rotor discs,
each rotor disc being angularly incremented from another by 15 degrees.

9. The axial flux switched reluctance motor of claim 1 wherein each stator element is an axially and substantially radially oriented lamination stack of electrical steel.

10. The axial flux switched reluctance motor of claim 1 wherein each rotor pole is an axially and substantially radially oriented lamination stack of electrical steel.

11. A method of manufacturing an axial flux switched reluctance motor comprising:
fitting a plurality of rotor poles to a rotor disc and spacing each of the rotor poles circumferentially about a periphery thereof;
mounting one or more of the rotor discs axially along a rotor shaft rotatably mounted in a motor housing;
supporting at least one stator element in the motor housing, arranging at least one pair of stator poles of the at least one stator element axially to straddle the rotor disc for forming dual axial air gaps therebetween wherein the stator element connects each stator pole of each pair of stator poles with a back iron portion, and spacing the back iron portion radially outwards from the periphery of the rotor disc for forming a slot therebetween; and
fitting a stator coil to each slot for each pair of stator poles and each stator coil adapted for electrical coupling for switched reluctance control wherein upon a switching on of each stator coil energizes its respective pairs of stator poles for forming an axial and radially inward flux path for attracting circumferentially adjacent rotor poles to rotate the rotor disc and rotor shaft for urging the rotor poles inline with the energized pair of stator poles for minimizing the flux path.

12. The method of claim 11 wherein the mounting of one or more of the rotor discs further comprises:
mounting two of more rotor discs along the rotor shaft with an angular starting position of the plurality of rotor poles for each rotor disc being rotationally indexed to angularly distribute the rotor poles about the motor;
fitting a stator coil wound circumferentially about the periphery of the rotor disc and spaced therefrom and within the slots of each of the least one stator element, wherein each rotor disc and stator coil form a different phase.

13. The method of claim 12 wherein the mounting of two or more rotor discs comprises:
mounting three rotor discs along the rotor shaft; and
fitting three stator coils for forming three different phases.

14. The method of claim 12 wherein the mounting of two or more rotor discs comprises:
fitting m rotor poles to each rotor disc;
mounting n rotor discs along the rotor shaft and n stator coils for forming n three different phases, and wherein the rotationally indexing of the n rotor discs further comprising angularly indexing the angular starting position of each rotor disc phase from another by 360/n/m degrees.

15. The method of claim 12 wherein the stator element has an axial height between a top edge and a bottom edge and a radial depth between an outward edge and an inward edge and wherein the manufacture of the stator elements further comprises:
assembling the stator element from a stack of a plurality of stator laminations, each stator lamination having the axial height and the radial depth; and
forming each of the stator laminations from a longitudinally extending strip of electrical steel, the strip having a transverse width equal to the element axial height, and the axial height of each stator lamination being oriented substantially across the entire transverse width of the strip.

16. The method of claim 12 wherein stator laminations are formed from the strip with the outside edge of a first adjacent stator lamination as the inside edge of a second adjacent stator lamination.

17. The method of claim 16 wherein the forming of each of the stator laminations further comprises forming a rotor pole lamination from a portion of the strip removed from the slot for each stator element in each stator lamination.

18. The method of claim 12 wherein the stator element has an axial height between a top edge and a bottom edge and a radial depth between an outward edge and an inward edge and wherein the manufacture of the stator elements further comprises:
assembling the stator element from a stack of a plurality of stator laminations, each stator lamination having the axial height and the radial depth; and
forming each of the stator laminations from a longitudinally extending strip of electrical steel, the strip having a transverse width equal to the element radial depth, and the radial depth of each stator lamination being oriented substantially across the entire transverse width of the strip.

19. The method of claim 18 wherein stator laminations are formed from the strip with the top edge of a first adjacent stator lamination as the bottom edge of a second adjacent stator lamination.

20. The method of claim 19 wherein the forming of each of the stator laminations further comprises forming a rotor pole lamination from a portion of the strip removed from the slot for each stator element in each stator lamination.

21. The method of any one of claim 12 wherein the motor housing comprises a stator housing between bearing end caps, the method further comprising:
inserting the stator elements radially through slots in the stator housing with the stator poles axially straddling the rotor discs; and
securing the stator elements to the stator housing.

22. The method of claim 21 further comprising inserting insulative wedges through ports in the stator housing to position the insulative wedges between radially adjacent stator elements.
